(19) United States
(12) Patent Application Publication
(10) Pub. No.: US 2023/0128058 A1
(43) Pub. Date: Apr. 27, 2023

(54) TYRE SEALANT, VEHICLE PNEUMATIC TYRE COMPRISING THE SEALANT, AND METHOD FOR DETECTING A VEHICLE PNEUMATIC TYRE COMPRISING A SEALANT AND FOR RECYCLING A VEHICLE PNEUMATIC TYRE COMPRISING A SEALANT

(71) Applicant: Continental Reifen Deutschland GmbH, Hannover (DE)

(72) Inventors: Mikheil Doroshenko, Garbsen (DE); Andreas Tyburski, Ilsede (DE)

(73) Assignee: Continental Reifen Deutschland GmbH, Hannover (DE)

(21) Appl. No.: 17/760,436

(22) PCT Filed: Nov. 30, 2020
(86) PCT No.: PCT/EP2020/083931

§ 371 Date: Aug. 9, 2022

(30) Foreign Application Priority Data
Feb. 10, 2020 (DE) 10 2020 201 584.8

(51) Int. Cl. B29D 30/06; B29B 17/02

(52) U.S. Cl. CPC B29D 30/0685; B29B 17/02; B29B 2017/0279; B29D 2030/0686

(57) ABSTRACT

Tire sealant, pneumatic vehicle tire comprising the sealant and process for detecting a pneumatic vehicle tire with a sealant layer and for recycling a pneumatic vehicle tire with a sealant

The invention relates to an automatically sealing tire sealant and a pneumatic vehicle tire having the sealant and a method for detecting a pneumatic vehicle tire with sealant and a method for recycling a pneumatic vehicle tire with sealant. The sealant according to the invention comprises at least one luminescent agent.

The pneumatic vehicle tire according to the invention has the sealant according to the invention at least on the inner surface opposite the tread.

The tire according to the invention is identified or detected by means of the luminescent agent.

The invention relates to an automatically sealing tire sealant and a pneumatic vehicle tire having the sealant and a method for detecting a pneumatic vehicle tire with sealant and a method for recycling a pneumatic vehicle tire with sealant.

Self-sealing pneumatic vehicle tires are known for example from the applicant's DE 10 2006 059 286 A1. Here, standard tire constructions are subsequently provided with a sealant layer. The self-sealing sealant is a self-adhesive, viscous sealing compound which is applied as a layer from the inside in the radial direction in the projection region of the belt package to the radially innermost tire layer, the largely airtight inner layer. The sealant layer is capable of automatically sealing punctures of up to 5 millimeters in diameter. After a puncture through the tread to through the inner layer, the sealant completely surrounds the penetrating foreign body, seals the interior off from the environment and hence prevents loss of compressed air from the tire. The driver of the vehicle is not forced to replace the defective tire immediately with an equivalent replacement wheel or an emergency wheel.

The sealant is notable for airtightness, high tackiness and balanced flow characteristics.

However, the strong tackiness of the sealant makes it difficult to recycle the tires. Tires—without sealant—are typically initially comminuted during recycling. Should the tires contain a tire comprising a sealant, the tackiness of the sealant severely impedes comminution since the sealant adheres to the comminution apparatus and impedes further comminution to an ever greater extent.

Pneumatic vehicle tires with and without sealant are optically difficult or impossible to distinguish from one another at first glance since the sealant is usually attached to the black inner wall of the tire as a black mass. The tires would therefore require more careful inspection one by one.

However, especially in the case of a multiplicity of tires, individual inspection of every tire by an operator would be very costly and inconvenient.

It is an object of the present invention, starting from the prior art, to provide a self-sealing tire sealant and a pneumatic vehicle tire comprising the tire sealant, wherein the tire sealant may be more easily and reliably detected.

This object is achieved when the sealant contains at least one luminescent agent.

As a result of the sealant containing at least one luminescent agent, the tires comprising the sealant are easier to distinguish from pneumatic vehicle tires without sealant.

The tires may in particular be distinguished with a detector, in particular a photodiode, after supply of energy in an automated process without any need for individual inspection of the tire by an operator.

However, any operator can also identify such a tire with a sealant more quickly and unambiguously as a result of the luminescence.

This simplifies and facilitates the recycling of pneumatic vehicle tires with sealant.

The operations of detection using a detector and identification by an operator are both referred to as “detection” in the context of the present invention.

As specified at the outset the present invention thus further provides a pneumatic vehicle tire which comprises the tire sealant according to the invention inclusive of all recited elucidations, at least on the inner surface opposite the tread.

The invention is more particularly elucidated hereinbelow and further advantageous embodiments are described. Unless otherwise stated or technically infeasible, different embodiments may also be combined with one another.

A “luminescent agent” is to be understood as meaning a substance/an agent which has luminescent properties. Such substances are also known as “fluorophores”.

According to Römpp Online Chemie Lexikon (last updated August 2008) “luminescence . . . is the emission of light in the visible, UV and IR spectral range of gases, liquids and solids after supply of energy”.

Depending on the type of energy supplied, a distinction can be made, for example, between photoluminescence, chemiluminescence, thermoluminescence and radioluminescence.

Types of luminescence that are caused in particular by photoluminescence include fluorescence and phosphorescence, wherein a distinction is made according to the duration between excitation (absorption of light) and luminescence (glowing through emission).

In the context of the present invention, the “luminescent agent” should not be restricted from the outset by a (formal) distinction between the different types of luminescence with regard to the type of excitation or the duration of the emission.

In advantageous embodiments of the invention, it is preferable when the luminescent agent is excitable by light and may therefore be described as a photoluminescent agent. It is further preferable when the luminescent agent has fluorescent or phosphorescent properties and is therefore a fluorescent agent or a phosphorescent agent.

In advantageous embodiments of the invention, it is preferable when the luminescent agent absorbs light in the wavelength range from 200 to 700 nm and emits light in the range from 350 to 800 nm. It may therefore be excited with UV light or visible light and may emit light in a range which is visible to humans and/or may be measured and thus detected using a photodiode.

The luminescent agent may in principle be any substance exhibiting luminescent properties and is therefore selected for example from the group comprising

coumarin derivatives such as methoxycoumarin,
peptides or proteins, such as green fluorescent protein (GFP), rhodamine,
organic substances available under the trade names Alexa Fluor®, for example Alexa Fluor® 350, Alexa Fluor® 405, Alexa Fluor® 488, Alexa Fluor® 532, etc,
quantum dots, for example QDOT® 525, QDOT® 565, QDOT® 665.

It is especially possible to employ all of the agents disclosed in the following sources:

https://docs.abcam.com/pdf/immunology/fluorochrome_guide.pdf
https://www.biosyn.com/Images/ArticleImages/Comprehensive % 20f luorophore % 20list.pdf
https://en.wikipedia.org/wiki/Fluorophore
https://en.wikipedia.org/wiki/Ethidium_bromide

In the event that the luminescent agent is a molecule, the weight average molecular weight (Mw) is for example and in particular from 200 to 250 000 g/mol.

In the event that the luminescent agent is quantum dots, the particle size (measured by dynamic light scattering) is for example from 2 to 2000 nm.

It is an essential feature of the invention that the sealant contains at least one luminescent agent.

Two or more different agents may also be present.

“At least one” refers to the type of luminescent agent. All elucidations apply both to the presence of one type of luminescent agent or two or more types of luminescent agents unless expressly stated otherwise.

Even the smallest amounts can have the desired luminescent effect.

In advantageous embodiments of the invention the sealant contains from 1% to 10% by weight of luminescent agents, wherein the amount that is suitable depends on the composition and in particular the hue of the sealant.

Especially in the event that the sealant contains dark- or black-coloring fillers it is preferable to use a relatively large amount of luminescent agents, for example 5% to 10% by weight.

In advantageous embodiments the sealant contains at least one filler which gives it the black hue. This may in particular be carbon black and/or graphite and/or graphene and/or carbon nanotubes.

Carbon black is in particular to be understood as meaning industrial carbon blacks and pyrolysis carbon blacks.

The sealant particularly preferably contains at least one carbon black, very particularly preferably at least one industrial carbon black.

This has the advantage that the cohesion of the sealant is increased and the tackiness of the sealant during the production process is reduced. The stationarity and the tear properties of the sealant are simultaneously improved.

In the context of the present invention all carbon black types known to a person skilled in the art are conceivable in principle.

In an advantageous embodiment of the invention a carbon black having an iodine adsorption number according to ASTM D 1510 of 20 to 180 g/kg, particularly preferably 30 to 140 g/kg, and a DBP number according to ASTM D 2414 of 30 to 200 ml/100 g, preferably 90 to 180 ml/100 g, particularly preferably 110 to 180 ml/100 g, is employed.

In a further preferred embodiment of the invention an N326-type carbon black is used.

A mixture of two or more carbon blacks is also conceivable.

In further advantageous embodiments, the sealant does not contain any dark- or black-coloring filler. In this embodiment of the invention a relatively small amount of luminescent agents may be selected, for example 1% to 2% by weight.

In advantageous embodiments the sealant may contain at least one silica for reinforcement. Silicas are known to those skilled in the art as light-colored fillers for tire mixtures.

This achieves optimal reinforcement of the sealant and good viscosity control and adjustment. In addition, the use of at least one silica increases the cohesion of the sealant and reduces the tackiness during the production process. The stationarity and the tear properties of the sealant are simultaneously improved.

A mixture of two or more silicas is also conceivable.

The silicas may be silicas known to those skilled in the art which are suitable as fillers for tire rubber mixtures. Employable silicas thus include for example not only those of the type Ultrasil® VN3 (trade name) from Evonik but also silicas having a relatively low BET surface area (such as for example Zeosil® 1115 or Zeosil® 1085 from Solvay) and highly dispersible silicas, so-called HD silicas (for example Zeosil® 1165 MP from Solvay).

Also conceivable and preferable is a mixture of the recited further fillers, such as in particular at least one carbon black in combination with at least one silica, which likewise affords the recited advantages.

In advantageous embodiments the sealant contains 1.0% to 30%, preferably 1% to 10% by weight, of at least one filler, wherein these are preferably light-colored fillers, such as in particular silicas.

The sealant may be selected from all suitable sealant compositions known to those skilled in the art, such as for example those based on silicone, or based on polyurethane or based on the crosslinking of a rubber and/or a polyolefin.

In an advantageous and exemplary embodiment the sealant contains at least one rubber.

The rubber may be selected from any rubber types known to those skilled in the art. A mixture of different rubbers is also conceivable.

In a preferred embodiment of the invention the rubber is natural rubber (NR) and/or butadiene rubber (BR) and/or isoprene rubber (IR) and/or styrene-butadiene rubber (SBR) and/or polychloroprene (CR) and/or butyl rubber (IIR) and/or bromobutyl rubber (BIIR) and/or chlorobutyl rubber (CIIR) and/or silicone rubber.

These rubber types are particularly well suited for the processing temperatures during the production of the sealant and later during the use, in particular in the pneumatic vehicle tire.

In exemplary embodiments the sealant may in particular contain natural and/or synthetic polyisoprene, preferably natural polyisoprene.

It is possible to employ, for example, solid natural rubber (NR) in conjunction with liquid polyisoprene.

The sealant may contain for example natural rubber and styrene butadiene rubber (SBR), for example ESBR (emulsion-polymerized styrene-butadiene rubber). The crosslinking may be based on peroxides and/or on sulfur crosslinking. For example sulfur may be used in conjunction with peroxidic agents, such as “VAROX-Organic-Peroxide-Crosslinking-Agents” from Vanderbilt Chemicals, LLC for example. The ratio of NR to ESBR is for example from 30% to 40% by weight to 60% to 70% by weight.

In further exemplary embodiments the sealant is a silicone-based sealant.

In an advantageous and exemplary embodiment the sealant is based on the crosslinking of a rubber and/or polyolefin. The elucidations above apply to the rubber.

It is apparent to those skilled in the art that all of the recited constituents in the crosslinked sealant are at least partially present in chemically altered form, in particular in the form of derivatives.

It is particularly preferable to employ at least butyl rubber (IIR). Butyl rubber is particularly well-suited since it exhibits a relatively high airtightness.

In a particularly advantageous embodiment of the invention the self-sealing tire sealant contains 40% to 80% by weight of at least one polyolefin. This achieves optimal flow characteristics coupled with good producibility (processability) of the sealant.

This achieves optimal flow characteristics coupled with good producibility (processability) of the sealant.

The at least one polyolefin preferably has a number-average molecular weight distribution Mn according to GPC of 400 to 2500 g/mol, particularly preferably 800 to 2500 g/mol, very particularly preferably 800 to 1600 g/mol, in turn preferably 1200 to 1600 g/mol, in turn particularly preferably 1200 to 1400 g/mol, for example 1300 g/mol.

A polyolefin having the recited ranges for Mn is particularly suitable for achieving the desired flowability and sealing activity of the sealant in the event of a puncture.

The at least one polyolefin is particularly preferably at least one polybutene.

This establishes the tackiness of the finished sealant and determines the flowability in the production process as well as the local stationarity of the finished sealant.

The at least one polyolefin may also be a mixture of two or more polybutenes each having an Mn of 400 to 2500 g/mol, wherein the polybutenes may differ in their Mn.

Suitable polybutenes, also known as polyisobutenes are obtainable for example under the trade name Indopol® polybutenes from INEOS Capital Limited.

A mixture of at least one polybutene with at least one other polyolefin is also conceivable.

The sealant is preferably based on crosslinking by at least one crosslinker selected from the group containing, particularly preferably consisting of, polymethylol resin and divinylbenzene and quinones. The quinone is preferably a quinone dioxime, for example dibenzoylquinone dioxime or para-benzoquinonedioxime. Para-benzoquinone dioxime is particularly preferred.

The sealant is preferably based on crosslinking by at least one crosslinker in conjunction with a crosslinking initiator, wherein the crosslinking initiator is preferably selected from the group containing lead oxide and other metal oxides and peroxidic compounds. The crosslinking initiator is a chemical compound that initiates the crosslinking of the sealant.

A peroxide compound is a chemical compound that contains at least one peroxide unit, i.e. —O—O— (wherein O=oxygen). Two or more peroxides may also be used. The peroxide(s) are preferably selected from the group consisting of diaroyl peroxides, diacyl peroxides and peroxyesters.

The crosslinking initiator may be added as a pure substance or in a mixture. In the case of a mixture, for example of 50% by weight of dibenzoyl peroxide in dibutyl maleate, only the amount of the peroxide present is included in the amount of crosslinking initiator and the accompanying substances such as dibutyl maleate are therefore disregarded in the reported amounts of the at least crosslinking initiator.

The sealant may contain further constituents, such as in particular further filler(s), tackifiers, plasticizers, for example oil(s), and optionally further additives, for example color pigments and/or zinc oxide and/or sulfur.

In further advantageous embodiments the sealant contains at least one tackifier, especially in the case where the sealant does not already exhibit a sufficient tackiness on account of the constituents, in particular the polymers, present. The term “tackifier” is in principle to be understood as meaning any substance which increases the tackiness of the sealant.

In advantageous embodiments of the invention the tackifier is at least one hydrocarbon resin.

It will be clear to those skilled in the art that hydrocarbon resins are polymers constructed from monomers, wherein the hydrocarbon resin is formally constructed from derivatives of the monomers by linkage of the monomers to one another.

In the context of the present application the term “hydrocarbon resins” comprises resins comprising carbon atoms and hydrogen atoms and optionally heteroatoms, such as especially oxygen atoms.

The hydrocarbon resin may be a homopolymer or a copolymer. In the present application the term “homopolymer” is to be understood as meaning a polymer which, according to Römpp Online (retrieved on Jan. 2, 2017, article last updated August 2008), “has been formed from monomers of only one type”.

In the context of the present invention “copolymer” is to be understood as meaning a polymer formed from a plurality of, i.e. two or more, different monomers. In the context of the present invention the hydrocarbon resin may therefore also be a copolymer of three different monomers for example.

The monomers may be any monomers of hydrocarbon resins that are known to those skilled in the art, such as aliphatic monomers, in particular aliphatic C₅ monomers, further cationically polymerized unsaturated compounds containing aromatics and/or terpenes and/or alkenes and/or cycloalkenes.

Preferred monomers are in particular C₅ and C₉ monomers.

The aromatics (aromatic monomers) may be for example alpha-methylstyrene and/or styrene and/or vinyltoluene and/or indene and/or coumarone and/or methylindene and/or methylcoumarone and/or phenol.

The aromatic monomers are preferably alpha-methylstyrene and/or styrene and/or vinyltoluene and/or indene and/or coumarone and/or methylindene and/or methylcoumarone.

According to Römpp Online the term “olefins” is the “common term for acyclic and cyclic aliphatic hydrocarbons having one or more reactive C═C double bonds in the molecule, nowadays better referred to as alkenes or cycloalkenes, and in the broader sense is also a term for the substituted derivatives thereof . . . . ” In the context of the present invention unsaturated terpenes, alkenes and cycloalkenes are thus encompassed by the umbrella term “olefins”.

The alkenes may be 1-butene and/or 2-butene and/or butadiene for example.

In a preferred embodiment of the invention the hydrocarbon resin is at least one aliphatic resin, i.e. a resin which contains no aromatic ring systems. Such a resin consists to an extent of 100% by weight of aliphatic monomers/derivatives thereof.

In a further embodiment of the invention the resin consists to an extent of 10% to 99% by weight, preferably 50% to 99% by weight, particularly preferably 70% to 99% by weight, of aliphatic monomers and to an extent of 1% to 90% by weight, preferably 1% to 50% by weight, particularly preferably 1% to 30% by weight, of aromatic monomers.

In a preferred embodiment of the invention the hydrocarbon resin is at least one resin constructed at least from C₅ monomers and known to those skilled in the art as so-called C₅ resin. This makes it possible to achieve particularly good properties of the sealant, in particular optimized flow characteristics coupled with good tackiness.

The aliphatic C₅ monomers may be monomers from the C₅ crude oil fraction, for example isoprene, and/or monomers of the terpenes and/or cycloolefins and/or olefins, for example pentene. The term “C₅” is to be understood as meaning that these monomers are constructed from five carbon atoms.

It is further known to those skilled in the art that apart from aliphatic monomers having five carbon atoms the C₅ crude oil fraction may also contain other aliphatic monomers (building blocks) having for example four carbon atoms, i.e. C₄ monomers, or six carbon atoms, C₆ monomers.

In an advantageous embodiment of the invention the sealant contains 2% to 20% by weight of at least one hydrocarbon resin as tackifier. The amount of the at least one hydrocarbon resin is preferably 2% to 10% by weight, particularly preferably 5% to 8% by weight.

Such preferred and particularly preferred amounts further optimize the tackiness and the viscosity of the adhesive.

In advantageous and exemplary embodiments of the invention the sealant contains the following components in the following amounts:
40% to 80% by weight of at least one polyolefin, preferably of at least one polybutene, and
2.0% to 20% by weight of at least one hydrocarbon resin and
9.0% to 15% by weight of at least one rubber and
1% to 10% by weight of at least one luminescent agent and
1.0% to 30% by weight of at least one filler and
0.4% to 1.0% by weight of at least one crosslinker and
0.5% to 2.5% by weight of at least one crosslinking initiator.

Further constituents are in particular plasticizers, such as oils.

For example the sealant contains the following components:
70% by weight of polybutene
3% by weight of hydrocarbon resin
10% by weight of butyl rubber
5% by weight of luminescent agent, Rhodamine 6G
2% by weight of silica, for example under the trade name Ultrasil® from Evonik
0.5% by weight of crosslinker
1.5% by weight of crosslinking initiator.

The reported amounts in % by weight are in each case based on the total amount of sealant.

The tire sealant according to the invention may be produced by processes known in the prior art, wherein the at least one luminescent agent is incorporated in a possible precursor of the sealant.

The sealant is applied to the inner surface of the tire using processes and apparatuses known to those skilled in the art.

The invention further provides a process for detecting a pneumatic vehicle tire according to the invention to distinguish pneumatic vehicle tires comprising a sealant from pneumatic vehicle tires without a sealant.

In the process according to the invention the sealant layer is detected optically by an operator or using a detector after supply of energy as a result of the at least one luminescent agent.

The detector may in particular be a photodiode.

Suitable detectors are known to those skilled in the art and are usually computer-aided.

The detector may further be a handheld device or a detector used in an automated process by a robot.

The invention further provides a process for recycling pneumatic vehicle tires according to the invention comprising at least the process steps of:

A) providing the pneumatic vehicle tire to be recycled;
B) performing the process according to the invention for detection of a pneumatic vehicle tire according to the invention as a result of the luminescence;
C) separating the sealant from the pneumatic vehicle tire;
D) subsequently comminuting the pneumatic vehicle tire without the sealant.

In advantageous embodiments the process steps A) to D) are carried out in an automated manner.

The invention further provides a process for recycling pneumatic vehicle tires comprising at least the process steps of:

a) providing pneumatic vehicle tires to be recycled;
b) performing the process according to the invention for detecting a pneumatic vehicle tire according to the invention in order to distinguish pneumatic vehicle tires with sealant from pneumatic vehicle tires without sealant;
c) spatially separating pneumatic vehicle tires comprising a sealant from pneumatic vehicle tires without sealant;
d) recycling pneumatic vehicle tires without sealant comprising comminution of the pneumatic vehicle tires;
e) transferring pneumatic vehicle tires comprising sealant to a separate recycling process comprising separation of the sealant and comminution of the pneumatic vehicle tires only subsequently.

In advantageous embodiments the process steps a) to e) are carried out in an automated manner. In an advantageous embodiment of the invention step c) is carried out in an automated manner in conjunction with step b).

1.-10. (canceled)

11. A self-sealing tire sealant for a pneumatic tire, the sealant comprising:
a filler to give a black hue;
rubber and/or polyolefin; and
and a luminescent agent.

12. The tire sealant of claim 11, the luminescent agent is a fluorescent agent or a phosphorescent agent.

13. The tire sealant of claim 11, the luminescent agent absorbs light in the wavelength range from 200 to 700 nm and emits light in the range from 350 to 800 nm.

14. The tire sealant of claim 11, the amount of luminescent agents is 1% to 10% by weight based on a total amount of sealant.

15. The tire sealant of claim 11, the filler which gives it a black hue is one or more of carbon black and/or graphite and/or graphene and/or carbon nanotubes.

16. The tire sealant of claim 11, the sealant is based on the crosslinking of a rubber and/or polyolefin.

17. The tire sealant of claim 11, the sealant formed on an inner surface of the tire.

18. A method of recycling a tire, the method comprising:
determining presence of a luminescent agent on the radially inward facing surface of a sealant layer of a tire;
removing the sealant layer based on the determined presence of the luminescent agent; and
recycling the tire based after removing the sealant layer.

19. The method of claim 18, determining the presence of the luminescent agent comprises using a photo-diode.
